(19) United States
(12) Patent Application Publication
(10) Pub. No.: US 2009/0263766 A1
(43) Pub. Date: Oct. 22, 2009

(54) STYLING HANDS

(76) Inventors: Melissa Ozuna, Redondo Beach, CA (US); Christine Kim, La Habra, CA (US); Erika Kane, San Pedro, CA (US)

Correspondence Address: KOLISCH HARTWELL, P.C., 200 PACIFIC BUILDING, 520 SW YAMHILL STREET, PORTLAND, OR, 97204, US

(21) Appl. No.: 12/427,638

(22) Filed: Apr. 21, 2009

Related U.S. Application Data
(60) Provisional application No. 61/125,058, filed on Apr. 21, 2008.

(51) Int. Cl. G09B 19/00; A45D 29/18; A45D 29/00

(52) U.S. Cl. 434/100; 132/73.5; 132/285

(57) ABSTRACT

The present disclosure provides toy sets which incorporate at least one manikin hand configured to removably secure one or more artificial fingernails so that they can be decorated.

This nonprovisional patent application claims benefit under 35 U.S.C. 119(e) of provisional patent application Ser. No. 61/125,058, filed Apr. 21, 2008, for STYLING HANDS, which is hereby incorporated by reference in its entirety.

### BACKGROUND

Children and young adults are often interested in imitating older women with regard to beauty preparations. For example, girls may often play dress-up either with dolls or by changing their own appearances with costumes or makeup.

Young girls may wish to practice painting and decorating fingernails, however the use of actual fingernail polish by small children may result in unwanted messes that may be difficult to clean.

Hand displays, artificial fingernails, and decorating aids may be found in U.S. Pat. Nos. 4,920,991; 5,011,445; 5,904,149; 6,035,857; 6,206,009; 6,363,943; and 6,488,506 the disclosures of which are incorporated herein by reference.

### SUMMARY OF THE DISCLOSURE

The present disclosure relates generally to a beauty preparation practice device. More specifically, it relates to a toy that allows a user to practice decorating fingernails.

The advantages of the present invention will be understood more readily after a consideration of the drawings and the Detailed Description.

### BRIEF DESCRIPTION OF THE DRAWINGS

FIG. 1 is a depiction of a toy set incorporating a pair of styling hands according to one embodiment of the invention.

FIG. 2 is a perspective view of a styling hand according to one embodiment of the invention.

FIG. 3 is detail view of a fingertip of the styling hand of FIG. 2.

FIG. 4 is a cross-section of the fingertip of FIG. 3.

### DETAILED DESCRIPTION AND BEST MODE

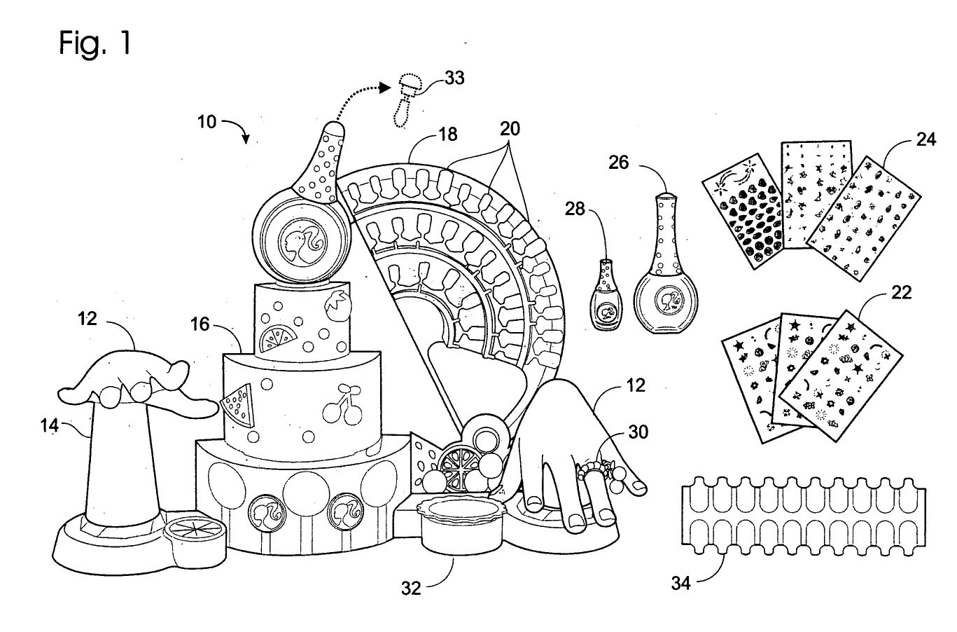

The present disclosure provides toy sets which incorporate at least one manikin hand configured to removably secure one or more artificial fingernails so that the artificial fingernails can be decorated. As shown in FIG. 1, the toy set 10 may include one or two manikin hands 12 (or styling hands), that are each optionally attached to manikin arms or arm segments 14. The hand may be fixed in place, or may incorporate one or more points of articulation, so that the hand may be posed as desired by the user for subsequent fingernail decoration. The hands may be affixed to a base 16 via arm segments 14, or may be attached directly.

The toy set may incorporate a theme or motif that is reflected in the aesthetics of the toy set components. For example, as shown for the toy set of FIG. 1, the overall aesthetic is one of fruit shapes. Alternative aesthetic themes may be envisioned that may be selected in order to appear more attractive to selected user groups.

The toy set of FIG. 1 includes a display stand 18 that is adapted to display a selection of artificial fingernails 20. In the particular example of the toy set of FIG. 1, display 18 includes three rows of displayed artificial fingernails 20. Display stand 18 may be configured to display the artificial fingernails in a manner complementary to the theme or motif of the toy set. The artificial fingernails may be displayed undecorated, or they may be arranged and displayed after they are decorated by a user.

The toy set may further include any of a variety of possible decorating supplies for decorating the artificial fingernails. The decorating supplies may include stickers, stencils, adhesive gems, glitter, and the like. In particular, the toy set may include rhinestones or other synthetic gems having adhesive backings, sheets of decals 22, and/or sheets of stickers 24.

The base 16 of the toy set may be configured to store and/or display supplies for decorating either the artificial fingernails 20 or the user's fingernails, or both. The base may optionally further include one or more additional compartments, that optionally include lids. Additional decorative elements, may serve to enhance the aesthetic theme, enhance manufacturer branding, or both.

The depicted toy set may be configured for use with young children, in which case liquid polish and liquid adhesives would be unadvisable due to the potential mess they might create. Alternatively, the toy set might include one or more containers of fingernail polish. For example, as shown in FIG. 1, the toy set may include a bottle of clear fingernail polish 26, and a container of glitter 28, which may be sprinkled on the clear polish after it is applied to the fingernail, and before it dries.

The toy set may also include jewelry, particularly jewelry worn on the hands such as bracelets and/or rings. The jewelry may be designed to be consistent with the theme or motif of the toy set. Typically, the jewelry will be selected to be consistent with the age of the intended user group. The toy set may further include one or more pieces of jewelry or other decorations, such as rings 30, that may be used on the manikin hands or worn by the user.

In order to avoid the difficulties associated with liquid paints or dyes, it is advantageous to utilize artificial fingernails 20 that are thermochromic. That is, the fingernails incorporate, or are painted or coated with a thermochromic material which exhibits a change in color in response to a temperature change. Toys incorporating thermochromic materials are often referred to as “color-change” toys, can provide interesting and amusing effects while not compromising the safety of a younger user. Suitable thermochromic materials may be obtained, for example, from the Pilot Ink Co. Ltd. (Nagoya, Japan).

Where the toy set includes thermochromic fingernails, the playset may include one or more accessories for facilitating a change in fingernail color. For example, the toy set may include a thermal pen or similar device configured to effect a temperature change (and therefore a color change) when applied to the fingernails. The thermal pen may be designed to raise the temperature of the fingernail above ambient temperature, or cool the temperature of the fingernail below ambient temperature, depending on the characteristics of the thermochromic material used. For example, the pen may include a reservoir which may be filled with chilled or warmed water in conductive thermal contact with the nib of the pen. Alternatively, the entire pen may be chilled in a refrigerator to cool, for example where the pen includes an insert having a high heat capacity. The nib of the thermal pen may be heated by, for example, resistive heating, or by use of a light source within the pen that generates sufficient heat.

However, any suitable cooling or heating method may be used to change the temperature of the thermochromic artificial fingernails. For example, the thermochromic artificial fingernails may be immersed in warm or cold water, and the toy set may include a container 32 for warm or cold water for this purpose. Alternatively or in addition, warm or cold water may be applied to the thermochromic artificial fingernails using a sponge or brush, such as sponge 33 in FIG. 1, which may be removed from the top of a faux nail polish bottle before use.

Fingernails 20 may be sized and dimensioned so that they can be affixed to the manikin hands 12, decorated as desired, and then removed from the manikin hands and placed on the user's own fingers.

The user may then employ the styling hands to secure the nails for decorating play, and subsequently wear the decorated nails themselves. The relatively permanent methods used by adults for attaching artificial fingernails may be impractical for younger users, and so a removable adhesive may be provided for attaching the fingernails to the user's fingers. For example, the toy set may include a plurality of adhesive patches 34 that are sized appropriately to secure the artificial fingernails 20 of the toy set to a user's own fingernails. It may be advantageous to use medical grade adhesive patches, such as are available from 3M (St. Paul, Minn.). As shown in FIG. 1, multiple adhesive patches 34 may be provided in the form of sheets of patches.

Any method of removably securing the fingernail to the fingertips of the manikin hands is a suitable method for the purposes of this disclosure. For example, a removable adhesive, or adhesive substance (such as double-sided tape) may be used to fix a fingernail in place. Alternatively a tacky, reusable substance such as a putty may be used to secure the fingernail.

In order to more closely match the fingernails of a user, and to provide a more lifelike appearance, the artificial fingernails of the toy set may be sized to match particular fingers on the manikin hands. That is, larger fingernails may be provided that match the nailbeds of the thumbs, while relatively smaller nailbeds would be provided to match the nailbeds of the smallest fingers.

In a preferred aspect of the disclosed toy set, the artificial fingernails are physically secured to the manikin hands as a function of the physical configuration of the fingertips of the hands.

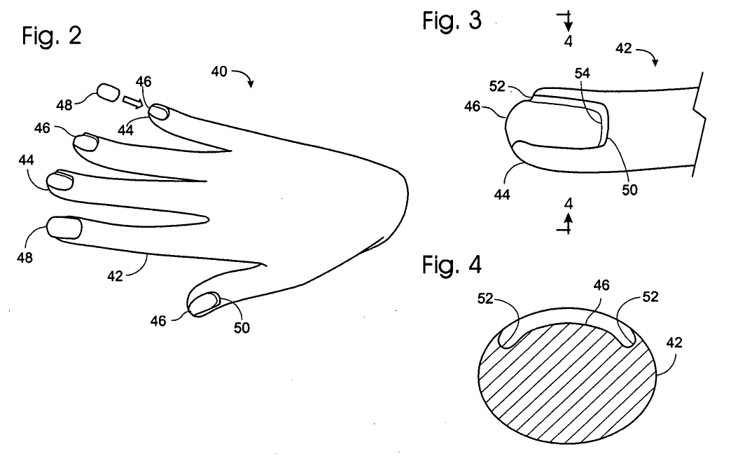

An exemplary manikin hand 40 is shown in FIG. 2. The manikin hands may be colored to match any of a variety of different ethnic-based complexions, so that a user may be able to enjoy a skin tone that matches their own complexion. The styling hands may be made of washable materials, so that any decorations accidentally applied to the hands may be easily removed.

As shown in FIG. 2, hand 40 includes a plurality of fingers 42. At the tip 44 of each finger 42 is an inset, or recessed, nailbed 46. Nailbed 46 may be colored differently than the rest of hand 40, in order to make the inset nailbed more obvious, and to provide an illusion of fingernails being present even when artificial fingernails are not affixed to the hand.

Each nailbed 46 may be configured so that it can receive and removably secure an artificial fingernail 48. As shown in FIGS. 2 and 3, the nailbed is at least partially defined by a raised lip 50. The raised lip defines at least a portion of the periphery of the nailbed 46, and the raised lip is shaped such that the inner surface 52 of the raised lip define a concavity, as shown in FIG. 4.

As shown in FIG. 2, a fingernail 48 can be removably secured to fingertip 44 by sliding into position onto the recessed nail bed 46. The sides of the raised lips defining the nail bed may form longitudinal slots, so the artificial fingernail 48 may be securely retained on the finger 42. However, the artificial fingernail may also be readily removed when desired, by reversing the process and sliding the fingernail off of the fingertip.

Retention of the artificial fingernail may be enhanced by providing a deeper, more pronounced concavity at the proximal end 54 of the nailbed 46. That is, a deeper concavity along the inner surface of the raised lip furthest from the tip of the finger, shown at 54 in FIG. 3. This deeper proximal concavity permits the artificial nail to more securely “seat” on the nailbed. Accordingly, the depth and/or shape of the concavities and the raised lip, as well as the physical configuration of the nailbed, may be configured to provide a desired degree of retention or the artificial nails on the fingertips.

Insertion and removal of the artificial fingernails alternatively or additionally may be facilitated by selecting a material for the manikin hand and fingers that is somewhat resilient and flexible. The resulting finger would then possess a raised lip that would be capable of flexing slightly to facilitate the insertion of the artificial fingernail, and then relax to securely retain the artificial fingernail. The material of the finger could then be flexed again to facilitate the removal of the artificial fingernail.

The toy set may be configured to be compact and easy to transport while providing an aesthetically pleasing appearance. The toy set optionally includes a cover to protect the styling hands, fingernails, and other toy set components. The cover may be translucent or transparent, and may itself be decorated in a manner consistent with the aesthetic theme.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where any claim recites “a” or “a first” element or the equivalent thereof, such claim should be understood to include incorporation of one or more such elements, neither requiring nor excluding two or more such elements.

Although the present invention has been shown and described with reference to the foregoing operational principles and preferred embodiments, it will be apparent to those skilled in the art that various changes in form and detail may be made without departing from the spirit and scope of the invention. The present invention is intended to embrace all such alternatives, modifications and variances that fall within the scope of the appended claims.

What is claimed is:

1. A toy set, comprising:
a manikin hand having a plurality of fingers, where at least one finger includes an inset nailbed, where the nailbed is configured to receive and removably secure an artificial fingernail, so that the secured fingernail is accessible for decoration.

2. The toy set of claim 1, wherein each of the plurality of fingers includes an inset nailbed that is configured to receive and removably secure an artificial fingernail.

3. The toy set of claim 1, further comprising at least one artificial fingernail that is appropriately configured to be securely inserted onto the inset nailbed.

4. The toy set of claim 1, where the inset nailbed is at least partially defined by a raised lip.

5. The toy set of claim 4, wherein an inner surface of the raised lip defines a concavity that is configured to retain the artificial fingernail when the artificial nail is inserted onto the nailbed.

6. The toy set of claim 5, wherein the concavity defined by the inner surface of the raised lip forms a pair of slots running the length of the longitudinal sides of the raised lip.

7. The toy set of claim 5, wherein the concavity is more pronounced at the proximal end of the nailbed.

8. The toy set of claim 5, wherein the raised lip is capable of flexing to facilitate the insertion of the artificial fingernail, relax to securely retain the artificial fingernail, and flex again to facilitate the removal of the artificial fingernail.

9. The toy set of claim 1, further comprising decorating supplies to decorate the artificial fingernails.

10. The toy set of claim 9, where the decorating supplies include at least one of stickers, stencils, adhesive gems, and glitter.

11. The toy set of claim 9, where the decorating supplies include one or more types of fingernail polish.

12. The toy set of claim 11, where the decorating supplies include clear fingernail polish and glitter for application to the fingernail polish.

13. The toy set of claim 1, further comprising a plurality of artificial fingernails that are thermochromic.

14. The toy set of claim 13, wherein the thermochromic fingernails are configured to exhibit a color change when cooled, further comprising a sponge or brush configured for applying cool water to the thermochromic fingernails.

15. The toy set of claim 1, further comprising adhesive suitable for securing an artificial fingernail onto a user's fingernail.

16. The toy set of claim 1, further comprising at least one article of toy jewelry sized to be worn by a user of the toy set.

17. A toy set, comprising:
two manikin hands, each hand at least partially posable and having a plurality of fingers, where each finger includes an inset nailbed at least partially defined by a raised concave lip, so that the each finger is configured to receive and removably secure an artificial fingernail.

18. The toy set of claim 17, further comprising a plurality of artificial fingernails, at least some of which are thermochromic artificial fingernails.

19. The toy set of claim 17, further comprising a supply of at least one of stickers, stencils, adhesive gems, and glitter.

20. The toy set of claim 17, further comprising a base supporting the manikin hands, the base further providing a display stand for the artificial fingernails.
